(19) United States
(12) Patent Application Publication
(10) Pub. No.: US 2005/0172823 A1
(43) Pub. Date: Aug. 11, 2005

(54) Poultry cooking device

(76) Inventor: Oscar Davis Riddle III, San Antonio, TX (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 10/773,420

(22) Filed: Feb. 9, 2004

(51) Int. Cl. A47J 37/10

(52) U.S. Cl. 99/345

(57) ABSTRACT

A poultry cooking device including a metal plate having a plurality of fingers partially cut therefrom. The fingers are folded such that they extend upwardly from the metal plate and leave a plurality of apertures in the metal plate when moved from their original positions. The fingers are located about the metal plate such that they define a keeper for snugly receiving a beverage container upon which a chicken can be impaled and cooked. The apertures are positioned around the keeper to hasten cooking and enhance flavor.

### FIELD OF THE INVENTION

The present invention relates generally to apparatus for preparing foods and beverages and, more particularly, to spit or impaling-type cookers.

### BACKGROUND OF THE INVENTION

Barbecuing whole chickens upon upright and open beverage containers formed of aluminum has become a rage. By partially filling the beverage containers with liquids such as beer or wine, the chickens are basted from the inside out as heat from barbeque grills cause the liquids to vaporize and fill the interior cavities of the chickens. Not only do the liquid vapors impart a nice flavor to the cooked chicken meat but such also prevent the meat from drying out. Chicken cooked in this manner is nearly always perfect.

Keeping chickens oriented in an upright manner on beverage containers has proven to be something of a tricky problem. Chickens, unfortunately, are not evenly balanced. Furthermore, typical beverage containers have a bottom with a surface area of only a few square inches which is not nearly enough to solidly support a chicken. Thus, light bumps to grills can tip over and spoil chickens perfectly balanced on beverage containers. Some have proposed implements that essentially expand the surface area at the bottom of a beverage container to make such less prone to tipping over, but these implements have not seen widespread use because of their complex and cumbersome natures.

### SUMMARY OF THE INVENTION

In light of the problems associated with the known implements for cooking chickens upon beverage containers, it is a principal object of the invention to provide a poultry cooking device that will effectively support a chicken impaled upon an upright beverage container that is uncomplicated in its construction, is intuitive to use, and is inexpensive to manufacture. The device can be used in association with: a barbecue grill, an oven, a stovetop, or an open fire.

It is another object of the invention to provide a poultry cooking device of the type described that is formed by cutting and bending a single metallic sheet. The device is lightweight, virtually unbreakable and durable enough to withstand repeated use.

It is a further object of the invention to provide a poultry cooking device of the type described that can be employed to simultaneously cook a pair of chickens on an outdoor barbecue grill. If desired, each chicken can be internally basted with a different liquid.

Still another object of the invention is to provide a poultry cooking device of the type described that channels poultry drippings onto a heat source such as barbecue briquettes during the cooking process to minimize the effort required to clean-up the device after use and to enhance the barbecue flavor imparted to the poultry by generating smoke. Simultaneously, the device directs heat and smoke to the one or more chickens that it supports for even cooking.

It is a further object of the invention to provide a poultry cooking device of the type described that can be employed to easily carry one or more chickens to and from a grill. Once on the grill, the device can be easily moved about to optimally cook one or more chickens.

Briefly, the poultry cooking device in accordance with this invention achieves the intended objects by featuring a plate having a number of apertures therein. The apertures have inner ends that are positioned closely adjacent to one another and outer ends that are positioned remote from one another. The inner ends of the apertures define a closed geometric form. Additionally, a number of fingers extend upwardly from the plate, with a respective one of the fingers being secured to the plate at the inner end of each of the apertures.

The foregoing and other objects, features and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is a perspective view of a poultry cooking device in accordance with the present invention.

FIG. 2 is a side elevational view of the poultry cooking device of FIG. 1 with portions broken away to reveal details thereof and, also, supporting a beverage container upon which a chicken is impaled.

FIG. 3 is a top view of the poultry cooking device.

FIG. 4 is a top view of the blank used to form a poultry cooking device.

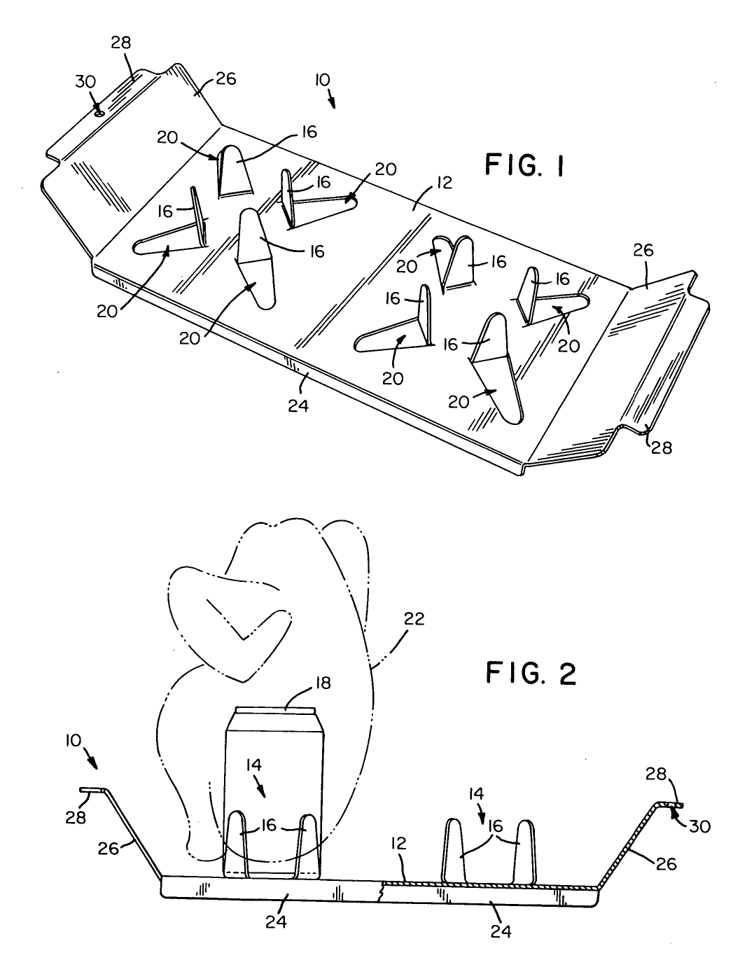

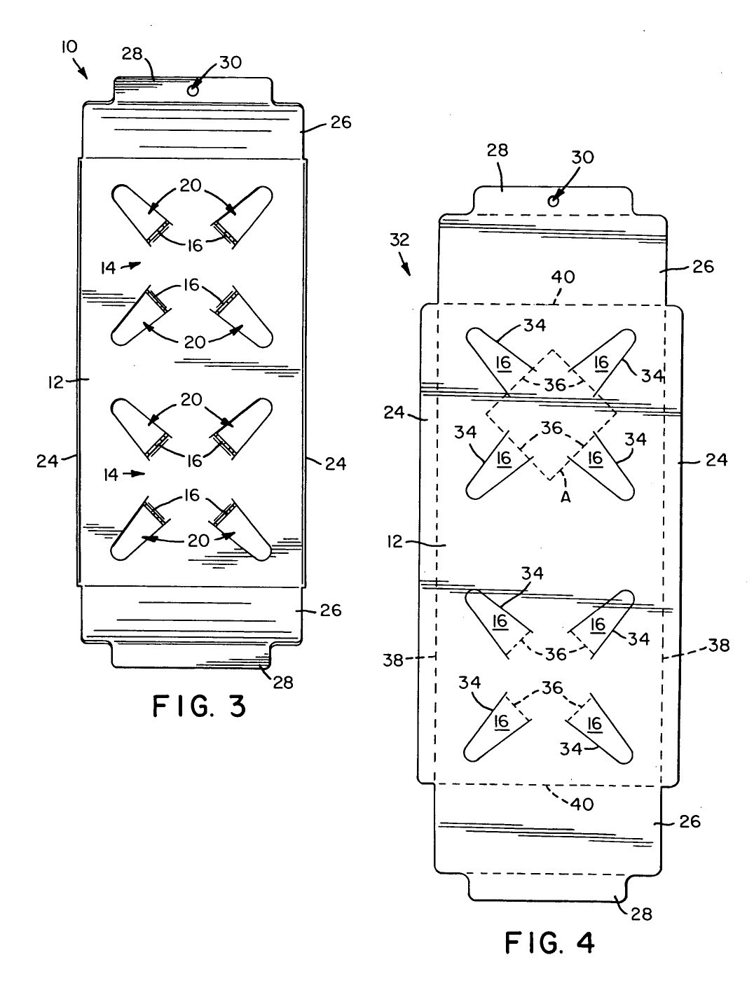

Similar reference characters denote corresponding features consistently throughout the accompanying drawings.

### DETAILED DESCRIPTION OF THE PREFERRED EMBODIMENT

Referring now to the FIGS., a poultry cooking device in accordance with the present invention is shown at 10. Device 10 includes a plate 12 having a pair of container keepers 14 positioned along the length thereof. Each keeper 14 has number of upstanding fingers 16 spaced from one another so as to snugly, yet releasably, receive the bottom of a beverage container 18. Adjacent each of the fingers 16 is an aperture 20 that permits heated air to pass upwardly to a chicken 22 impaled on container 18 and, also, allows any juices flowing from chicken 22 to drain downwardly through plate 12.

Plate 12 is rectangular in outline and is sufficiently sized to steadily support a pair of containers 18 upon which a pair of chickens 22 is impaled. To bear such a load, plate 12 is reinforced around its periphery by longitudinal and lateral fins 24 and 26. As shown, a pair of longitudinal fins 24 is secured to the front and back of plate 12 with each of longitudinal fins 24 extending downwardly from plate 12. A pair of lateral fins 26, however, is secured to the opposite sides of plate 12 with each of lateral fins 26 extending upwardly and outwardly from plate 12. To permit device 10 to be more easily grasped and carried, an outwardly extending tab 28, oriented substantially parallel to plate 12, is secured to the outer end of each of lateral fins 26. Thus, each lateral fin 26 and its associated tab 28 serves as a handle for device 10.

A hole 30 is placed in one of lateral fins 26 so as to permit device 10 to be suspended from a support (not shown) for convenient storage when not in use.

Each container keeper 14 includes four fingers 16 arrayed such that their linear bottoms define an imaginary square “A,” i.e., a closed geometric form, whose sides have a length that is substantially equivalent to the diameter of container 18 and are inclined about 45° to the sides of plate 12. This configuration permits fingers 16 to be made, as will be more fully described below, relatively large in size and without substantially weakening plate 12. Of course, the number of fingers 16 provided to each keeper 14 is largely a matter of design choice with any number of fingers 16 capable of retaining a container 18 atop plate 12 being suitable.

Each finger 16 is substantially flat and triangular in outline, being wide at its bottom and tapering to a narrowed top for enhanced rigidity and strength. The bottom of each finger 16 has a length that is about one-half of the diameter of container 18. The height of each finger 16 is about one-half of the height of container 18. Due to the relatively large dimensions of each finger 16, it is very difficult to dislodge a container 18 from a keeper 14 with a sideways below even while the container 18 is supporting a chicken 22. Always, container 18 must be elevated a substantial portion of its height above plate 12 to remove such from the grasp of fingers 16.

An aperture 20 is positioned adjacent to each one of the fingers 16 and extends outwardly from each keeper 14. Each aperture 20 is triangular in outline, having substantially the same shape as the finger 16 that borders such at its inner end. As shown, each aperture 20 is wide at its inner end and tapers to a narrowed outer end to ensure that the principal flow of air through plate 12 will take place immediately adjacent to each keeper 14 to speed the cooking of chicken 22.

Device 10 is formed by cutting and folding portions of a planar blank 32 formed from a single piece of sheet metal. First, fingers 16 are made by cutting a plurality of V-shaped notches 34 at suitable locations in blank 32 and, then, folding the material within notches 34 to an upright position along retainer fold lines 36 that “close” the open ends of notches 34. It is the voids left within notches 34 by the production of fingers 16 that form apertures 20. Next, the boundaries of plate 12 are defined by folding longitudinal fins 24 downwardly along longitudinal fold lines 38 at the front and back of plate 12 and further defined by folding lateral fins 26 upwardly along lateral fold lines 40. Finally, tabs 28 are provided to device 10 by folding the outer ends of lateral fins 26 downwardly along handle fold lines 42.

The use of device 10 is straightforward. First, one or a pair of open containers 18 are partially filled with a liquid such as beer, wine or water. Then, the bottoms of containers 18 are fitted within keeper 14, fingers 16 holding containers 18 firmly atop plate 12. Next, one or a pair of previously cleaned chickens 22 are impaled upon containers 18 so that such appear to be seated upon plate 12. Afterward, device 10 is placed within a barbecue grill or oven (not shown) and chickens 22 are cooked until done. Any juices flowing from chickens 22 will pass through apertures 20 to a heat source within the grill or oven and produce smoke that will impart an appealing flavor to chickens 22. Heated air and smoke from a heat source will flow upwardly through apertures 20, cooking chickens 22 rapidly and flavorfully. Simultaneously, the liquid within containers 18 will boil and fill chickens 22 with moisture, thereby basting chickens 22 from their interior during cooking.

Once chickens 22 are fully cooked, device 10 is lifted from the barbecue grill or oven by grasping tabs 28. Chickens 22 are, then, removed from containers 18 and carved, served and consumed in a conventional manner. Later, after being permitted to cool down, containers 18 are withdrawn from keepers 14 and discarded. Finally, device 10 is washed with soap and water and, by means of hole 30, suspended from a support to dry and to be reused when desired.

While the invention has been described with a high degree of particularity, it will be appreciated by those skilled in the art that modifications may be made thereto. Therefore, it is to be understood that the present invention is not limited to the sole embodiment described above, but encompasses any and all embodiments within the scope of the following claims.

1. A poultry cooking device comprising a metal plate having a plurality of fingers partially cut therefrom, said fingers being folded such that they extend upwardly from said metal plate thereby leaving a plurality of apertures in said metal plate, said fingers being disposed about said metal plate such that they define a keeper capable of snugly receiving a beverage container therein and preventing said beverage container from sliding about said metal plate, and said apertures being disposed around said keeper.

2. The poultry cooking device according to claim 1 wherein said metal plate is rectangular in form and is reinforced about the periphery thereof by means of longitudinal and lateral fins that extend angularly therefrom.

3. The poultry cooking device according to claim 2 wherein said lateral fins extend upwardly from said metal plate and are provided with outwardly extending tabs at the upper ends thereof so as to serve as handles for said poultry cooking device.

4. The poultry cooking device according to claim 1 wherein said plate is provided with a pair of keepers positioned side-by-side.

5. A poultry cooking device comprising a metal plate having a plurality of fingers partially cut therefrom, said fingers being folded upwardly from said metal plate thereby leaving a plurality of apertures in said metal plate, said fingers being triangular in outline and being wider at the bottom thereof than at the top thereof, said fingers being disposed about said metal plate such that they define a keeper for snugly receiving a beverage container and preventing said beverage container from sliding about said metal plate, said apertures radiating outwardly from said keeper, and said apertures also being triangular in outline being wider at the inner ends thereof adjacent said fingers than at the outer ends thereof remote from said fingers.

6. The poultry cooking device according to claim 5 wherein said metal plate is rectangular in form and is reinforced about the periphery thereof by means of longitudinal and lateral fins that extend angularly therefrom.

7. The poultry cooking device according to claim 6 wherein said lateral fins extend upwardly from said metal plate and are provided with outwardly extending tabs at the upper ends thereof so as to serve as handles for said poultry cooking device.

8. The poultry cooking device according to claim 6 wherein said plate is provided with a pair of keepers.

9. A poultry cooking device, comprising:
a plate having a plurality of apertures with inner ends being positioned closely adjacent one another and outer ends being positioned remote from one another, said inner ends defining a closed geometric form; and,
a plurality of fingers extending upwardly from said plate, a respective one of said fingers being secured to said plate at the inner end of each of said apertures.

10. The poultry cooking device according to claim 9 wherein said fingers are triangular in outline, being wider at the bottoms thereof than at the tops thereof.

11. The poultry cooking device according to claim 9 wherein said apertures are triangular in outline, being wider at the inner ends thereof than at the outer ends thereof.

12. The poultry cooking device according to claim 9 and further comprising a pair of longitudinal fins extending downwardly from the front and back of said plate.

13. The poultry cooking device according to claim 12 wherein said plate includes a pair of opposed ends connecting the front and back of said plate and further comprises a pair of lateral fins extending upwardly and outwardly from said opposed ends.

14. The poultry cooking device according to claim 13 and further comprising a pair of tabs extending outwardly from said lateral fins so as to serve as handles.
